(19) United States
(12) Patent Application Publication
(10) Pub. No.: US 2011/0197855 A1
(43) Pub. Date: Aug. 18, 2011

(54) Apparatus and Method For Recovering Fuel

(76) Inventor: Eric Johnson, Vail, AZ (US)

(21) Appl. No.: 13/018,154

(22) Filed: Jan. 31, 2011

Related U.S. Application Data
(60) Provisional application No. 61/299,780, filed on Jan. 29, 2010.

(51) Int. Cl. F02M 55/02

(52) U.S. Cl. 123/445

(57) ABSTRACT

A new and useful apparatus and method for recovering fuel is provided, that is particularly useful for recovering fuel from a vehicle fuel system in which fuel is normally pumped to the vehicle engine. In a method and apparatus according to the principles of the present invention, fuel is recovered from a fuel supply system (e.g. a vehicle fuel system) in which fuel is normally directed, under pressure from a fuel pump to an engine (generally via a fuel rail that is connected directly to a fuel supply line). The fuel is recovered by connecting a drain conduit that comprises a single fluid conduit directly to the fuel line in a manner that provides a connection to only one point in the fuel line (and bypasses the fuel rail and the engine), initiating operation of the fuel pump (without starting the engine), to cause the fuel pump to pump fuel in the fuel line directly to the drain conduit. Thus, fuel is drained to the drain conduit, by operating the fuel pump without starting the engine, and draining fuel through the single conduit, while bypassing the fuel rail and the engine.

### RELATED APPLICATION/CLAIM OF PRIORITY

This application is related to and claims priority from provisional application Ser. No. 61/299,780, filed Jan. 29, 2010, which provisional application is incorporated by reference herein.

### BACKGROUND

The present invention relates to a new and useful apparatus and method for recovering fuel from a system in which fuel is normally pumped to an engine, and particularly to an apparatus and method for recovering fuel from a vehicle fuel system.

The broad concept of recovering fuel from a system, e.g. a vehicle fuel system, is known. Mitchell US published patent application 2009/0283174 describes some of the reasons why it is desirable to recover fuel from vehicles, and discloses how that applicant proposes to accomplish that objective. That applicant's preferred way of accomplishing the objective is to provide a T shaped coupler, and to connect the T shaped coupler to at least two points in a fuel supply system, including a fuel line and an engine fuel rail, and to a dump system, and to provide a metering valve in the dump system to either regulate the amount of fuel directed to the dump line and to the engine fuel rail, or to block flow to the dump line, and enable all fuel to be directed to the engine fuel rail.

### SUMMARY OF THE PRESENT INVENTION

The present invention provides a significantly different approach to recovering fuel that would otherwise be directed to a fuel rail of an engine, in a manner that achieves all of the stated objectives of the Mitchell published application, and improves the manner in which those objectives are accomplished. In particular, the present invention is designed so that fuel is recovered in a manner that does not involve running the engine, or directing fuel to a fuel rail. In fact, the principles of the present invention provide a method and apparatus for recovering fuel, in a manner that connects to only one point in the fuel supply system, the fuel supply line, completely bypasses the fuel rail, and enables recovery of fuel without turning on the engine.

In a method and apparatus according to the principles of the present invention, fuel is recovered from a fuel supply system (e.g. a vehicle fuel system) in which fuel is normally directed, under pressure from a fuel pump to an engine (generally via a fuel rail that is connected directly to a fuel supply line). The fuel is recovered by connecting a drain conduit that comprises a single fluid conduit directly to the fuel line (bypassing the fuel rail and the engine), initiating operation of the fuel pump (without starting the engine), to cause the fuel pump to pump fuel in the fuel line directly to the drain conduit. Thus, fuel is drained to the drain conduit, by operating the fuel pump without starting the engine, and draining fuel through the single conduit, while bypassing the fuel rail and the engine.

Other features of the present invention will become further apparent from the following detailed description and the accompanying drawings.

### BRIEF DESCRIPTION OF THE DRAWINGS

FIG. 1 is an illustration of a mobile system that can be used in the recovery of fuel from one or more vehicles, in accordance with the principles of the present invention;

FIG. 2 is an illustration of a drain conduit with a two way valve and a fitting, for use with an apparatus and method according to the principles of the present invention;

FIG. 3 is a schematic illustration of the basic structure and principles by which fuel is drained from a vehicle, according to the principles of the present invention;

FIG. 4 is an illustration of a portion of a system that can be used in draining fuel from a plurality of vehicles, according to the principles of the present invention; and

FIG. 5 is a schematic illustration of the method by which fuel is drained from a vehicle, according to the principles of the present invention

### DETAILED DESCRIPTION

As discussed above, the present invention relates to a new and useful apparatus and method for recovering fuel from a system in which fuel is normally pumped to an engine, and particularly to an apparatus and method for recovering fuel from a vehicle fuel system. The principles of the present invention are described herein in connection with an apparatus and method for recovering fuel from one or more vehicles, and from that description, the manner in which the principles of the present invention can be used to recover fuel from various types of systems will be apparent to those in the art.

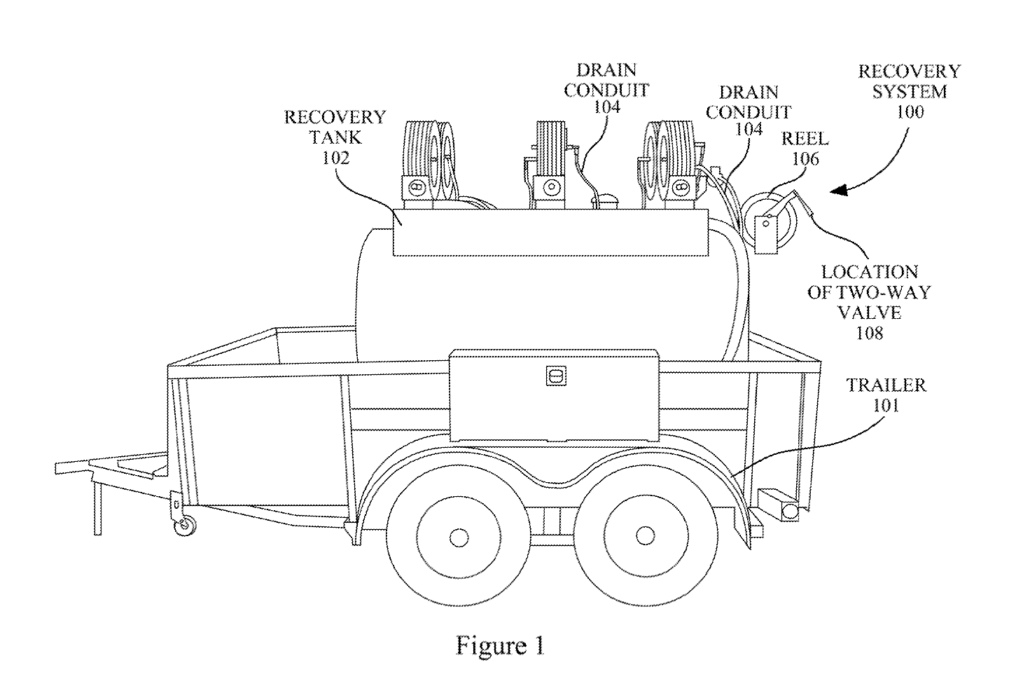

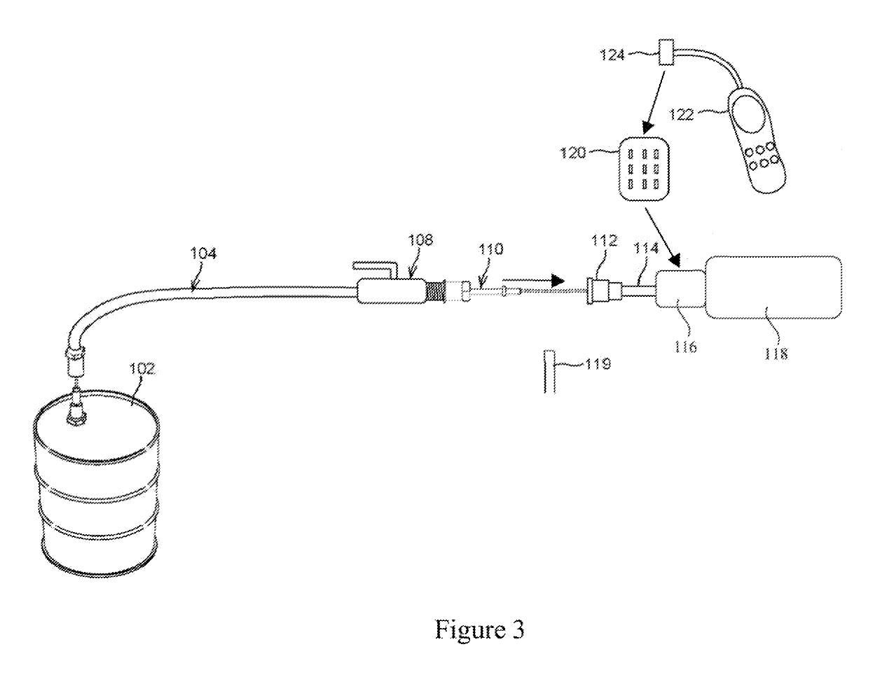

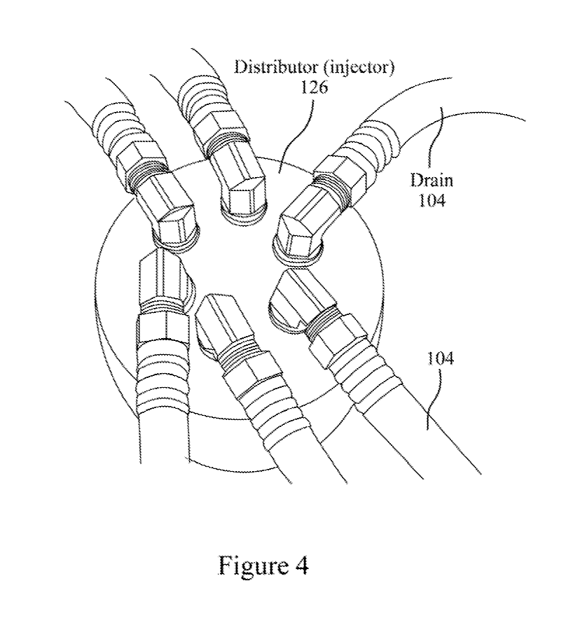

The apparatus for recovering fuel from a vehicle, and the method for recovering fuel from a vehicle, according to the principles of the present invention, can be practiced with a recovery system 100 shown in FIG. 1, which is carried by a trailer 101. A fuel recovery tank 102 (sometimes referred to as a storage tank) is carried by the trailer, and fuel recovered from the vehicles is delivered to the fuel recovery tank 102. A series of drain conduits 104 are connected with the fuel recovery tank 102 (via a distribution/injector structure described below and shown in FIG. 4). Each drain conduit 104 is supported on a reel 106 that enables the drain conduit to be extended when it is being used to recover fuel from a vehicle. As shown in FIG. 3, at the distal end of the drain conduit 104 there is a two way valve 108, with a fitting that enables a tip 110 to be coupled to the two way valve (preferably via a threaded connection).

The tip 110 has a configuration that is similar to the configuration of a tip that would normally connect a fuel rail 119 of a vehicle to a fitting 112 of a fuel line 114. The tip 110 has an internal conduit to produce fluid flow through the tip. The fuel line 114 is connected with a fuel pump 116 that draws fuel from a fuel tank 118, and normally pumps the fuel to the fuel rail 119 of the vehicle.

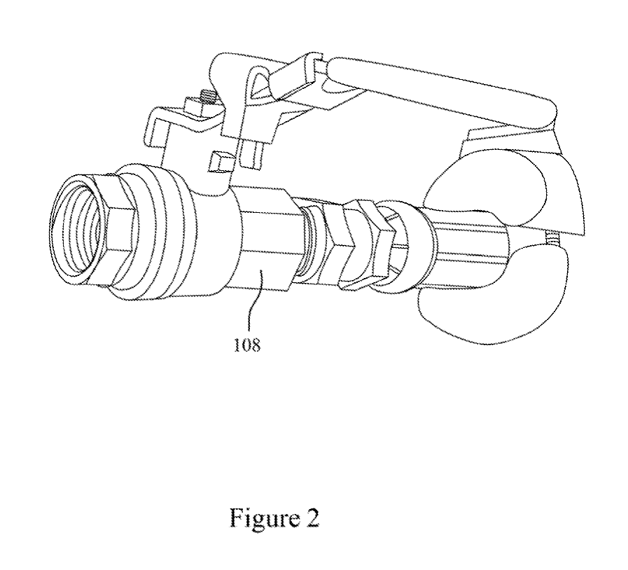

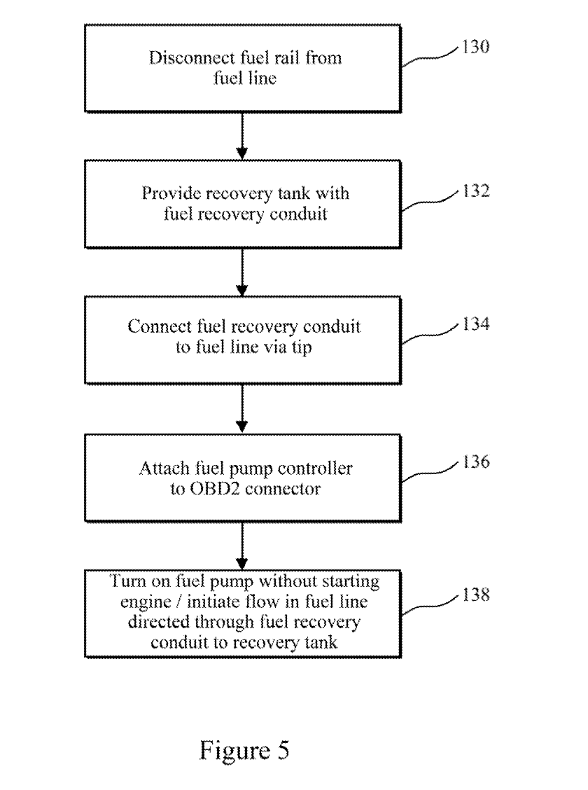

The operation of the method of the invention, using the apparatus of the present invention, can be appreciated from FIGS. 1-3 and 5. In normal operation of the vehicle, when the ignition switch is turned on, the fuel pump 116 is actuated (by an electrical signal), the engine (not shown) is turned on, and fuel is pumped from the fuel tank 118 to the vehicle engine via a connection between the fuel line 114 and the fuel rail 119. When the vehicle is not operating (the engine is not running), and it is desired to recover fuel from the vehicle fuel tank 118 and fuel line 114, the fuel rail 119 is disconnected from the fuel line 114 (see block 130 in FIG. 5). The fuel recovery system is connected to the fuel line by coupling the tip 110 to the two way valve 108 directly to the fitting 112 on the fuel line 114, so that a single conduit is established directly from the fuel line to the drain conduit 104 (see 132, 134 in FIG. 5). A fuel pump controller 122, which is of conventional design, is coupled to the OBD2 connector 120 of the vehicle (which is also of conventional design). The controller 122 is initiated by a switch 124, and initiates a circuit connection between the OBD2 connector and the fuel pump 116, to turn on the fuel pump 116, without turning on the vehicle engine (the circuit connection can be of any conventional type, such as wired, wireless, remote control, etc). The fuel pump 116 initiates fuel flow in the fuel line 114, and the single conduit directs the fuel directly to the drain conduit 104 and to the tank 102, bypassing the fuel rail 119, and without starting the engine (see 136, 138 in FIG. 5).

Thus, with the method and apparatus of the present invention, fuel is recovered from a fuel supply system (e.g. a vehicle fuel system) in which fuel is normally directed, under pressure from the fuel pump to an engine (generally via the fuel rail that is connected directly to a fuel supply line). The fuel is recovered by connecting the drain conduit to the fuel line in a manner that establishes a single fluid conduit from the fuel line to the drain conduit, which bypasses the fuel rail and the engine, and initiating operation of the fuel pump (without starting the engine), to cause the fuel pump to pump fuel in the fuel line directly to the drain conduit. Thus, fuel is drained to the drain conduit, by operating the fuel pump without starting the engine, and draining fuel through the single conduit, while bypassing the fuel rail and the engine.

Additional comments on a preferred example of a trailer that can be used in recovering fuel from one or more vehicles, in accordance with the principles of the present invention.

a. The trailer 101 is preferably a dual 3500# axle trailer equipped with G rated radial tires and electric brakes.

b. The fuel recovery tank 102, which receives and stores recovered fuel, is preferably a UL 142 listed and approved 500 gallon all steel fuel storage tank custom built by Tyco manufacturing in Tucson, Ariz.

c. The trailer 101 preferably includes safety features such as electric brakes, a break-away system, grated steel safety platform for easy access to the trailer, and flip away heavy duty trailer jack assembly. The trailer includes required federally mandated pressure relief valves for proper release of fuel vapors. Moreover, the trailer would be equipped with stage one vapor recovery units installed to insure compliance with the new stricter EPA regulations. In addition, the trailer is provided with two vapor tubes, the first is for use while the unit is being transported to and from a facility at which it is used, the second additional vent tube for use while in operation.

d. The reels 106 are preferably UL listed anti-static reels.

e. The trailer 101 may include a pump for dispensing fuel directly from the storage tank. The pump would preferably be a UL listed explosion proof pump with electrical connectors.

f. All tanks on the trailer come equipped with an accurate fuel level sight glass for easy recognition of fuel levels within the tank.

g. The fuel distribution/injection system is designed to enable fuel to be recovered from several vehicles. The fuel distribution system (also referred to as the injection system) safely transfers the fuel from the vehicles from which fuel is being recovered to the tank. FIG. 4 shows the distributor 126 that distributes fuel from several drain conduits 104 to the recovery tank 102.

h. Fuel can be recovered from a vehicle through the tip(s) 110, that are specially produced to properly fit into the fittings 112 of the fuel lines of different vehicle types in a leak proof manner, and each of which includes a fuel grade locking ball valve to prevent a fuel spill from occurring.

i. One or more solar panels may be installed on the trailer to power the unit. This eliminates the need for an internal combustion engine as the power source. Power from the solar panel(s) is stored in an onboard deep cycle battery in a sealed compartment. All connections in the electrical system are made using explosion proof UL listed connectors.

j. The trailer is DOT certified, with 4 fire extinguishers, all required information placards, and reflective DOT tape. One of the four onboard fire extinguishers is strategically placed in an appropriate location to address the unlikely case of an incident. The trailer also has a box of reflective triangles in case of a roadside emergency as required by the DOT. The trailer also includes spill kits that are preferably larger than standard spill kits on a semi-truck tanker, and include containment rings, spill diapers, safety goggles, rubber gloves, and clean-up disposal bag. The trailer includes a 5 gallon fire bucket for safe storage of used rags. The two way value 108 is preferably a solid brass corrosion proof two way valve on the drain conduit 104 to control the flow of recovered fuel being deposited into the fuel recovery tank 102.

k. The trailer has a stage one vapor recovery system designed to make the fuel recovery system compliant in all 50 United States and Canada. The trailer is also equipped with a dual purpose delivery and vapor recovery collar. This collar enables the operator to simultaneously deliver fuel and recover vapors in one step. The collar is also universal to fit older as well as newer tank coupling styles. Manual lock handles, easy carry handle, oversize gaskets, and a sight glass are standard on delivery collars. Dual purpose collar with delivery hose and vapor recovery hose attached are also provided.

Thus, the foregoing description demonstrates how the principles of the present invention are used for recovering fuel from a system in which fuel is normally pumped to an engine, e.g. in a vehicle fuel system. With the foregoing disclosure in mind, it is believed that various ways of recovering fuel from a fuel delivery system, according to the principles of the present invention, will be apparent to those in the art.

1. A method for recovering fuel from a fuel supply system in which fuel is normally directed, under pressure from a fuel pump, through a fuel line to a fuel rail associated with an engine, via a first coupling device on the fuel line that mates directly with a second coupling device on the fuel rail, the method comprising connecting a drain conduit directly to the fuel line, via a coupling member on the drain conduit that mates directly with the first coupling device on the single conduit that comprises the fuel line, to establish a single fluid conduit from the drain conduit to the fuel line, which connects to only one point in the fuel line and bypasses the fuel rail, and initiating operation of the fuel pump to produce flow of fuel in the fuel line and to establish a flow of fuel in the single conduit directly from the fuel line to the drain conduit, while bypassing the fuel rail.

2. The method of claim 1, wherein draining fuel from the fuel line is initiated by initiating operation of the fuel pump without initiating operation of the engine.

3. Apparatus for use in recovering fuel from a fuel supply system in which fuel is normally directed, under pressure from a fuel pump, through a fuel line to a fuel rail associated with an engine, via a first coupling device on the fuel line that mates directly with a second coupling device on the fuel rail, the apparatus comprising a drain conduit that is configured as a single conduit, and a coupling member on the drain conduit that mates directly with the first coupling device on the fuel line, and connects to only one point in the fuel line, thereby establishing a single fluid conduit from the drain conduit to the fuel line, which bypasses the fuel rail, so that initiating flow of fuel in the single fluid conduit results in the fuel flowing directly to the drain conduit, bypassing the fuel rail.

4. The apparatus of claim 3, including a device for initiating operation of the fuel pump, the device being in circuit communication with the fuel pump in a manner that enables the device to initiate operation of the fuel pump without initiating operation of the engine.
